(19) United States
(12) Patent Application Publication
(10) Pub. No.: US 2006/0123131 A1
(43) Pub. Date: Jun. 8, 2006

(54) Method and apparatus and system for performing seamless mobility

(76) Inventors: Jay R. Almaula, Bartlett, IL (US); Anwar M. Haneef, Streamwood, IL (US); Jayanth P. Mysore, Streamwood, IL (US)

Correspondence Address: MOTOROLA, INC., 1303 EAST ALGONQUIN ROAD, IL01/3RD, SCHAUMBURG, IL, 60196, US

(21) Appl. No.: 11/001,832

(22) Filed: Dec. 2, 2004

(51) Int. Cl. G06F 15/16; G06F 15/173

(52) U.S. Cl. 709/231; 709/224

(57) ABSTRACT

An independent server is established to track the state of content being rendered on a client device. A content server (alternatively referred to as an application server) maintains a backchannel with the independent server and updates session state. When migrating content from a first client device to a second client device, the second client device will access the server prior to rendering the content. Upon accessing the server, the second client device will be provided with the state of the current session.

### FIELD OF THE INVENTION

The present invention relates generally to seamless mobility, and in particular, to a method, apparatus, and system for performing seamless mobility.

### BACKGROUND OF THE INVENTION

The vision of seamless mobility includes the ability to migrate multi-media sessions between differing devices. For example, imagine you are listening to your favorite music from the comfort of your home, but you have to go out. You transfer the music to your phone while you walk to your automobile, and then transfer the music from the phone to your auto as you drive away. While moving from the home to the car, the music continues playing uninterrupted, as if emanating from a single device.

A major obstacle encountered in seamless mobility is to have the digital content pick up at a new device in the same state that it left off the old device. In case of a music session, the current state may include the current elapsed time etc. Therefore, a need exists for a method, apparatus, and system for performing seamless mobility that allows a user's session to seamlessly migrate to a new device starting on the new device exactly where it left off at the old device

### BRIEF DESCRIPTION OF THE DRAWINGS

FIG. 1 is a block diagram illustrating seamless mobility.

FIG. 2 is a block diagram showing a state database server and a client device.

FIG. 3 is a flow chart showing operation of a client device rendering digital content.

FIG. 4 is a flow chart showing operation of a client device that is being passed digital content in accordance with a first embodiment of the present invention.

FIG. 5 is a flow chart showing operation of a client device that is being passed digital content in accordance with a second embodiment of the present invention.

FIG. 6 is a flow chart showing operation of a content server in accordance with the first embodiment of the present invention.

FIG. 7 is a flow chart showing operation of a state database server.

FIG. 8 shows the steps necessary for a content server to update a state database server.

### DETAILED DESCRIPTION OF THE DRAWINGS

To address the above-mentioned need an independent server is established to track the state of content being rendered on a client device. In one embodiment, the client device automatically (or alternatively upon a user's action) updates the server with the state of the content being rendered. Alternatively, the content server (alternatively referred to as an application server) itself maintains a backchannel with that independent server and updates session state, witch has the advantage of not requiring any changes in the client. When migrating content from a first client device to a second client device, the second client device will access the server prior to rendering the content. Upon accessing the server, the second client device will be provided with the state of the current session (e.g., amount of media rendered, volume, play lists, . . . , etc.). By providing the second client device with the current session state of the session, a user will be able to seamlessly migrate to the second client device and have the content continue where it left off at the old device.

The present invention encompasses a method comprising the steps of receiving a request to stream digital content to a client device, receiving a current session state of the digital content, and streaming the digital content to the client device based on the current session state. The current session state is updated by updating an external server with the current session state.

The present invention additionally encompasses a method comprising the steps of receiving session state updates from an application server, receiving a request for digital content from a client device, and providing the client device with an address for the application server holding the digital content. The client device is provided with a session state for the digital content.

The present invention additionally encompasses a method for operating a content server. The method comprises the steps of providing digital content to an external client, determining a current session state for the digital content, and providing the current session state of the digital content to an external server.

The present invention additionally encompasses an apparatus comprising a receiver receiving a request to stream digital content to a client device and receiving a current session state of the digital content. The apparatus additionally comprises a transmitter streaming the digital content to the client device based on the current session state and transmitting the current session state to an external server.

The present invention additionally comprises an apparatus comprising a receiver receiving session state updates from an application server and receiving a request for digital content from a client device. The apparatus additionally comprises a transmitter providing the client device with an address for the application server holding the digital content, and providing the client device with a session state for the digital content.

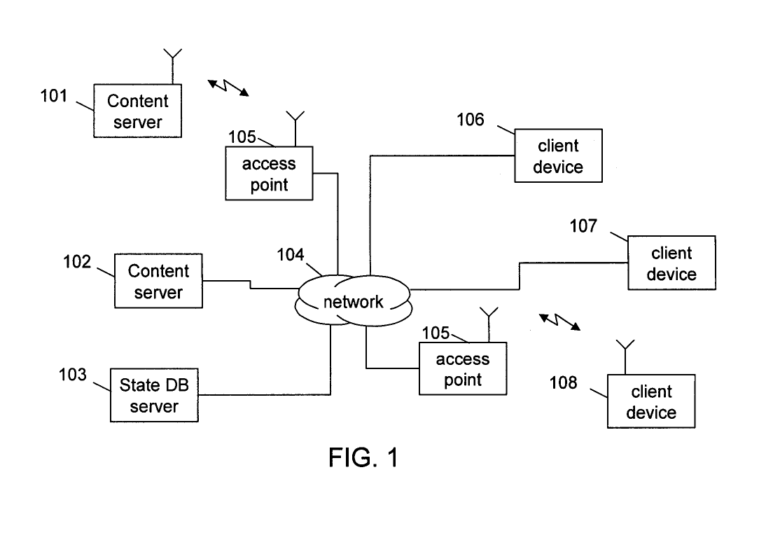

Turning now to the drawings, wherein like numerals designate like components, FIG. 1 is a block diagram illustrating seamless mobility. Content servers 101 and 102 are provided to hold media content (or any digital content). In a first embodiment, the digital content is streamed to client devices 106-108, while in a second embodiment, the digital content is provided as a digital file to devices 106-108. Forms of digital content include, but are not limited to content such as digital music, games, video, pictures, books, maps, software, . . . , etc. Client devices 106-108 comprise devices such as computers, cellular telephones, personal digital assistants, digital music players, . . . , etc. that are capable of running an application that renders the digital content. For example, client device 106 may be a personal computer equipped with an application to “play” an MPEG Audio Layer 3 (MP3) file, with an application such as standard MP3 software. Client device 107 may comprise a cellular telephone equipped to play an MP3 file and/or an MPEG Video Layer 4 file with a standard MPEG video codec. Other possible embodiments for client devices 106-108 include, but are not limited to, set-top boxes, car radios, networked MP3 players, personal digital assistants (PDAs), . . . , etc.

Content servers 101-102 provide digital content to devices 106-108 via network 104, however, in alternate embodiments the digital content may be provided via a direct link to devices 106-108, either wired or over-the-air. Network 104 may take various forms such as but not limited to a cellular network, a local-area network, a wide-area network, . . . , etc. For example, client device 108 may comprise a standard cellular telephone, with network 104 comprising a cellular network such as a Code-Division, Multiple-Access communication system, with access point 105 comprising a standard cellular base station. Additionally, client device 108 may comprise an MP3 player capable of communication over a local-area network, with network 104 using an IEEE 802.11, 802.16, or 802.21 system protocol, and access point 105 being a wireless gateway. Regardless of the form that devices 106-108, servers 101-102, and network 104 take, digital content is stored on servers 101 and 102 and provided to client devices 106-108 when requested.

As discussed, a major obstacle to seamless mobility is to have the digital content migrate to a new device in a similar state as it left the old device, instead of having the session simply restart when migrating to the new device. In order to address this issue, state database server 103 is provided to monitor the state of the current session (e.g., amount of media rendered, volume, list of media to be rendered, etc.). Any device 106-108 wishing to render the current session will be able to determine the current session state by accessing state database server 103, allowing a user's session to seamlessly pick up at a new device where it left off at the old device. To migrate a session (i.e., the current rendering of a digital file) from a source client device to a destination client device, the source client device simply needs to terminate the current session after providing the session parameters to state database server 103. Alternatively, state database server 103 could instruct the content server 101 to force migration of the current session after capturing the necessary session state from the content server. In the first embodiment, the end client may need to send state information that could potentially infringe upon the user's privacy. A server based solution is more secure in this respect. Subsequently, a new session is launched on the destination client device using session parameters obtained from state database server 103 matching the earlier session state (e.g., amount of media rendered, volume, play lists, . . . , etc.).

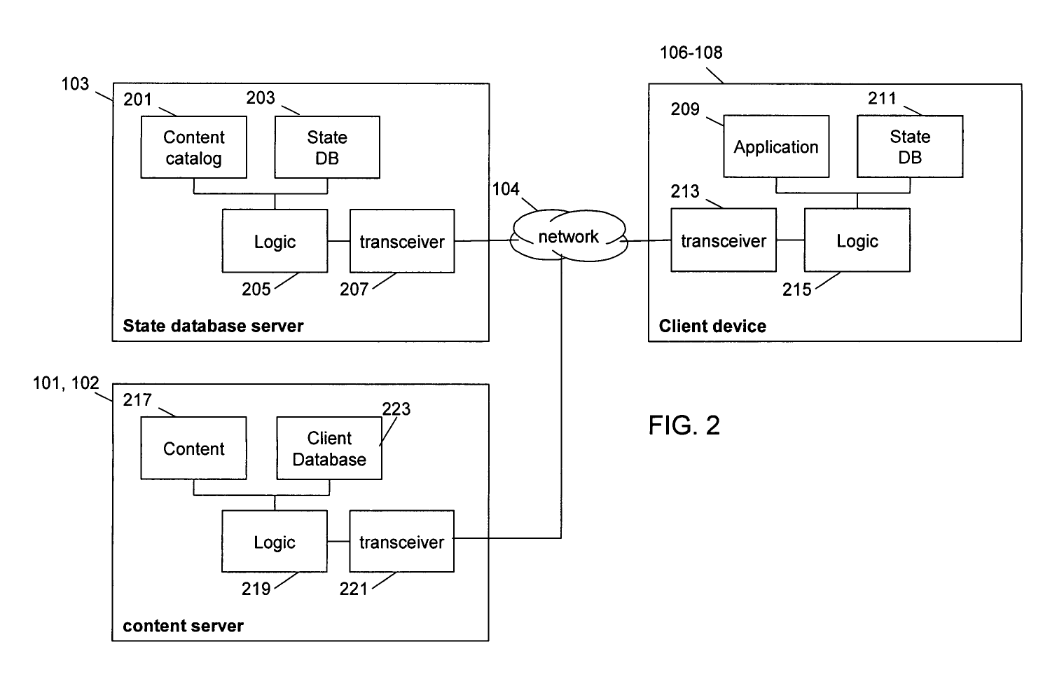

FIG. 2 is a block diagram showing state database server 103, a client device, and a content server. State database server 103, client devices 106-108, and content server 101, 102 comprise logic circuitry 205, 215, and 219, respectively. Additionally, these devices comprise and transceivers 207, 213, and 221 respectively. Logic circuitry 205, 215 and 219 preferably comprises a microprocessor controller such as but not limited to a Freescale PowerPC, a Motorola MC68328 DragonBall integrated microprocessor, or a TI OMAP1510 processor. Additionally transceivers 207, 213 and 221 comprise a transmitter and receiver, and are common circuitry known in the art for communication utilizing well known communication protocols, and serve as means for transmitting and receiving messages and content between devices. Possible system protocols include, but are not limited to wired/wireless protocols such as the neuRFon™ system protocol, the Bluetooth protocol, the IEEE 802.11 system protocol, HyperLAN protocols, or any cellular communication system protocol.

Application 209 is preferably computer code that is designed to render digital content 217. For example, application 209 may comprise computer software designed to “play” an MPEG Audio Layer 3 (MP3) file or software designed to “play” a video file such as an MPEG Video Layer 4 file utilizing a standard MPEG video codec. Regardless of the form application 209 takes, application 209 is designed to periodically provide logic circuitry 215 with the current session state of the content being rendered. This can be accomplished by application 209 storing this information in state database 211, or simply passing the information directly to logic circuitry 215. Logic circuitry 215 periodically provides state information to state database server 103 for storage in state database 203.

During streaming, content (application) servers 101, 102 provide updated session information to state database server 103. This is accomplished by logic circuitry 219 periodically providing state database server 103 with updated state information for particular sessions being streamed by the content server.

Finally, state database server 103 preferably comprises content catalog 201 comprising a list of available digital content. Any user can access (e.g., via network 104) catalog 201 and request digital content from catalog 201. In return, logic circuitry 205 returns a message that contains an address (e.g., a URL) where the content is located. More particularly, the address comprises the address of a content server hosting the requested file. Along with the content server hosting the requested file, logic circuitry 205 accesses state database 203 and provides the requester with the current session state of the content being requested.

In order to provide accurate session state information on digital content being requested, logic circuitry 205 must associate the request with a current session. This is accomplished by use of a session identification (discussed in detail below).

During operation application 209 renders digital content 217. As discussed, the session state of the digital content is provided periodically to state database 203. This is either accomplished via application 209 periodically updating state database 203, or alternatively, a content server updating state database 203. When migration is desired, a user signals the intent to migrate a session. For example, a user may “pause” a session before “tearing” it down. (Alternatively, the owner of the database 103 or the owner of the content server 101-102 could force such a migration.) This may indicate to logic circuitry 215 that a migration may occur causing the current session state to be provided to state database 203. When a second device 106-108 wishes to render the digital content, the second device accesses state database server 103 to determine an address of the content server hosting the requested file, and is provided with the address along with the current session state. The current session state is stored in state database 211. When the second device renders the digital content, it is rendered having the same session state (e.g., amount of media rendered, volume, . . . , etc.). So for example, if an MP3 song was 35% rendered on a first device, operating at a first volume level, the second device would begin playing the content 35% into the song, at the first volume level.

In a more-detailed example, assume a first MP3 player is 35% into playing a song at a first volume level. The MP3 player contains a play list of songs to be played. The user wishes to seamlessly migrate to a second MP3 player within their automobile. The above procedures will require the automobile's MP3 player to access state database server 103 to acquire the current session state of the first MP3 player and an address of the content server containing the digital content to be rendered. The automobile's MP3 player will access the appropriate content server and appropriately render the digital content. When moving to the car, the music continues to be played uninterrupted, at the same volume level, as if emanating from a single device. In addition, the play list is also transferred to the automobile's MP3 player.

It should be noted that application 209 may receive media from content servers 101, 102 in various forms. For example, a media file may simply be transferred to the client device, or alternatively may be streamed from the content server. The technique used to provide application 209 with the file will dictate what device utilizes the state information to allow the destination device to provide the content in the appropriate state. It will also dictate what device (i.e., the client device or the content server) updates state database server 103. Thus, in a first embodiment, where content is streamed from a content server, the content server is provided the current session state (either by the destination device, or alternatively by the state database itself) so that streaming may begin at the appropriate time. During streaming, the content server will update state database server 103.

Alternatively, in a second embodiment, where media files are provided to application 209, the client device only needs to request the appropriate files from a content server 101-102. Application 209 will analyze state database 211 to determine the session state and appropriately render the content in the correct session state. The client device will update state database server 103.

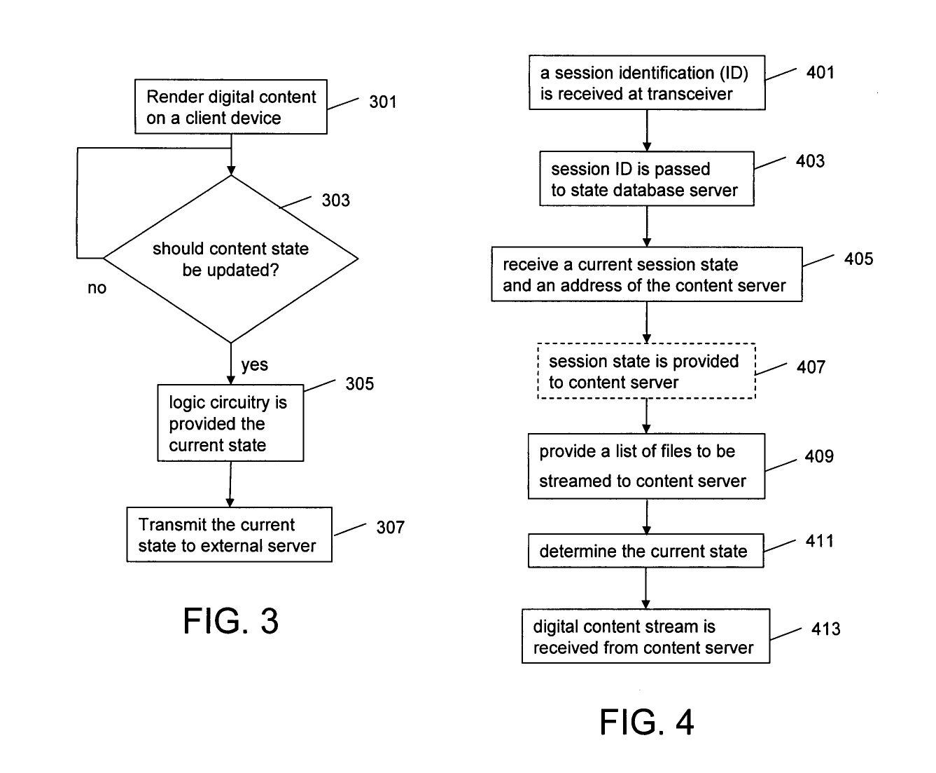

FIG. 3 is a flow chart showing operation of a client device rendering digital content. In particular, FIG. 3 shows those steps necessary to adequately update state database server 103. The logic flow begins at step 301 where digital content is being rendered on a client device. As discussed above, this procedure comprises application 209 rendering the digital content. At step 303 it is determined if the session state should be updated. As discussed this may be done periodically (i.e., once per second), or alternatively this may be done in response to a user's actions (i.e., when the digital content is stopped or paused or any indication is given by a user that a migration is to take place). Regardless of the method for determining if the session state should be updated, if at step 303 it is determined that the session state should not be updated, the logic flow simply returns to step 303. If, however, it is determined that the current session state should be updated, the logic flow continues to step 305 where logic circuitry 215 determines the current session state of the digital content. As discussed, providing the logic circuitry 215 with the current session state may be accomplished directly via application 209 accessing logic circuitry 215, or alternatively, by storing the current session state within state database 211. The logic flow continues to step 307 where logic unit 215 accesses transceiver 213, transmitting the current session state to external state database server 103.

FIG. 4 is a flow chart showing operation of a destination client device that is being passed digital content that is to be streamed from content server 101 or 102. The logic flow begins at step 401 where a session identification (ID) is received at transceiver 213 from a source client device. The session identification is associated with a particular play list and user. The session ID is passed (via transceiver 213) to state database server 103 (step 403). In response, at step 405 transceiver 213 receives a current session state and an address of the content server (e.g., server 101) hosting the content and stores this information in database 211. In a first embodiment the session state is provided to content server 101 (step 407) by transceiver 213, however, in an alternate embodiment, database state database server 103 may provide this information to content server 101. Regardless of who provides state information to content server 101, at step 409 logic circuitry provides a list of files to be streamed to content server 101 and at step 411 accesses state database 211 to determine the current session state. Finally, at step 413 digital content stream is received from content server 101 having the same state as currently existing on the source client device. As is evident, the current session state of the streamed content will be provided to state database server 103 as the content is rendered on the destination device.

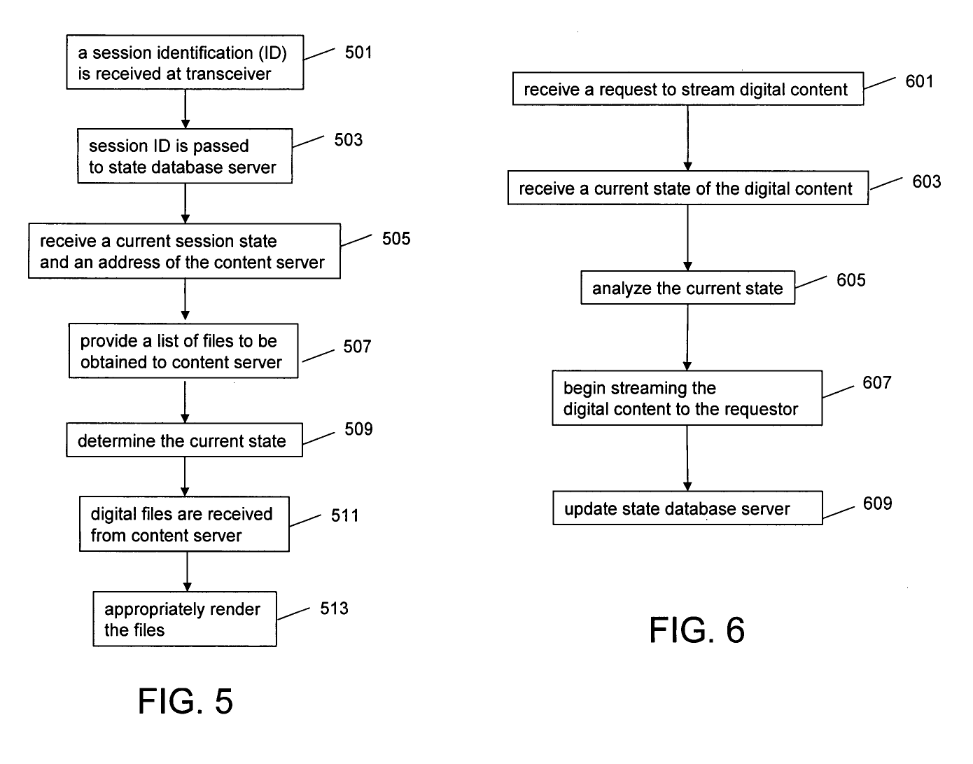

FIG. 5 is a flow chart showing operation of a destination client device that is being passed a media data file to be rendered. The logic flow begins at step 501 where a session identification (ID) is received at transceiver 213 from a source client device. The session identification is associated with a particular play list and user. The session ID is passed (via transceiver 213) to state database server 103 (step 503). In response, at step 505 transceiver 213 receives a current session state and an address of the content server (e.g., server 101) hosting the content and stores this information in database 211. At step 507 logic circuitry provides a list of files to be obtained to content server 101 and at step 509 accesses state database 211 to determine the current session state. At step 511 the digital files are received from content server 101. Finally, at step 513 the destination client device appropriately renders the files. As discussed above, the current session is started seamlessly. Additionally, the current session state of the streamed content will be provided to state database server 103 as the content is rendered on the destination device.

FIG. 6 is a flow chart showing operation of a content server that streams digital content to a client device. The logic flow begins at step 601 where the content server, and in particular receiver 221 receives a request to stream digital content from a client device. Along with the request for digital content, transceiver receives a current session state of the digital content (step 603). As discussed, the current session state comprises an amount of media rendered, a volume, play lists, . . . , etc. while the digital content comprises things such as music, games, video, pictures, books, or maps.

The current session state of the digital content preferably is received from the client device; however, in an alternate embodiment of the present invention, the current session state may come directly from state database server 103. In a further alternate embodiment of the present invention, a content server may determine a session state from an existing session being provided to a user. More particularly, if a received request's session identification matches an existing session being provided by the content server, the current state can be obtained by analyzing the current session being provided to the user. At step 605 logic circuitry 219 analyzes the current session state and begins streaming the digital content to the client device (step 607). The streaming maintains the current session state. In other words, the streaming is based on the current session state and will begin from the point where it left off of the source client device, having an amount of media rendered based on the current session state. In addition, all other session states (e.g., volume, . . . , etc.) will remain the same. Finally, at step 609, state database server 103 is periodically updated with the current session state via transmitter 221.

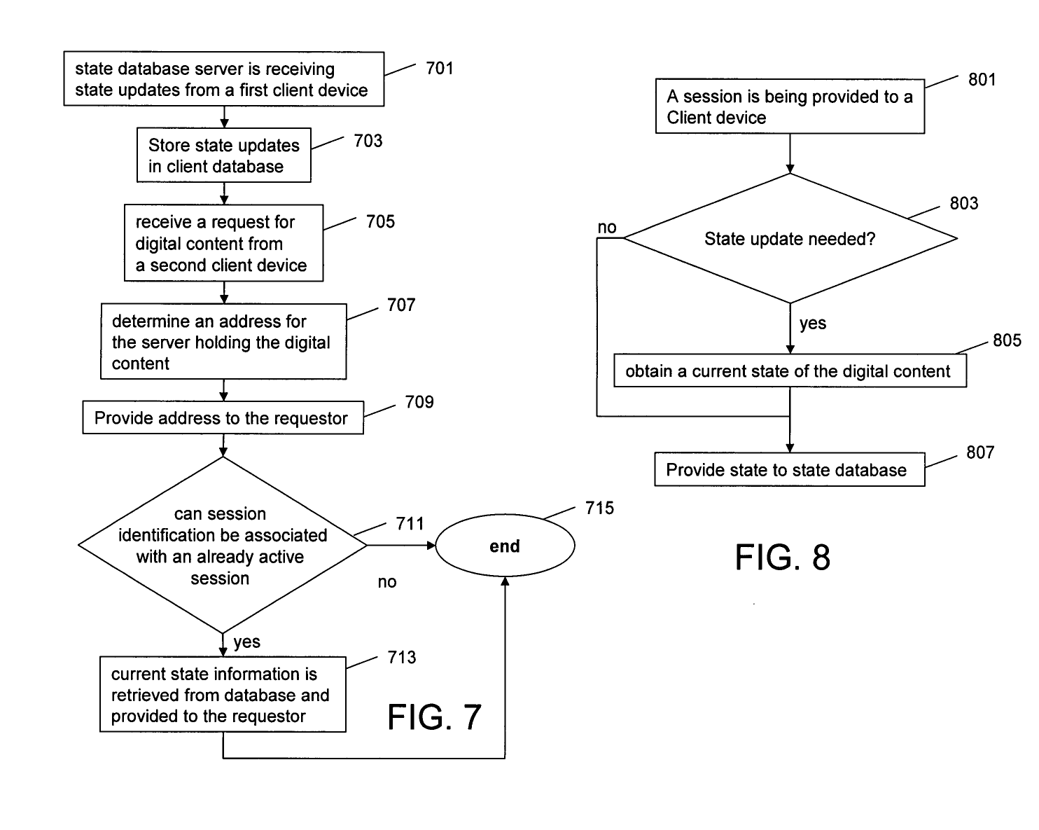

FIG. 7 is a flow chart showing operation of a state database server. The logic flow begins at step 701 where state database server 103 (transceiver 221) is receiving state updates from a first client device (e.g., client device 106) or a content (application) server. As discussed, such state updates include a session identification, a current amount of media rendered by device 106, a current volume of device 106, a current play on by device 106, . . . , etc. At step 703 this information is stored in client database 223. At step 705 transceiver 221 receives a request for digital content from a second client device, along with session identification. Logic circuitry 219 then accesses content database 217 to determine an address for the server holding the digital content (step 707), and the address is provided to the requestor at step 709. The logic flow then continues to step 711 where logic circuitry 219 attempts to associate the session identification with an already active session. If, at step 711, logic circuitry 219 associates the session identification with an already active session, the logic flow continues to step 713 where current session state information is retrieved from database 223 and provided to the requestor (client device). In an alternate embodiment, the state information may be directly provided to the server holding the digital content. The logic flow ends at step 715.

In an alternate embodiment, a client server will update state database server 103. The updating of state database server 103 in this manner will preferably take place when a client server is streaming digital content, and thus has immediate access as to the state. With this in mind, FIG. 8 shows the steps necessary for a content server to update state database server 103. The logic flow begins at step 801 where a session is actively being provided via transceiver 221 to a client device (e.g., client device 106). At step 803 it is determined by logic circuitry 205, if state update parameters are needed. As discussed, preferably the state parameters are obtained internally, however, if such state parameters are needed from the client, the client device may be accessed. Additionally, the determination to update state information may be based on a certain time period passing, or because of some client action. For example the state parameters may be updated every five seconds, or may be updated when the client hits “pause” or “stop”, . . . , etc.

Continuing, if at step 803 logic circuitry 205 determines that state parameters need to be updated, then the logic flow continues to step 805 where they are obtained (either internally, or from client device 106). If, however, at step 803 it is determined that state parameters are not needed from client device 106, the logic flow simply continues to step 807 where state information is provided, via transceiver 207, to state database server 103.

While the invention has been particularly shown and described with reference to a particular embodiment, it will be understood by those skilled in the art that various changes in form and details may be made therein without departing from the spirit and scope of the invention. For example, the above discussion does not require the web server and media server to be distinct products. In other words, both can be bundled as part of a single product. In this case, the messages described above, can be implemented as software interfaces that can be invoked using inter-process communication (IPC) mechanisms. It is intended that such changes come within the scope of the following claims.

1. A method comprising the steps of:
receiving a request to stream digital content to a client device;
receiving a current session state of the digital content;
streaming the digital content to the client device based on the current session state; and
updating the current session state by updating an external server with the current session state.

2. The method of claim 1 wherein the step of receiving the request to stream digital content comprises the step of receiving the request from the client device.

3. The method of claim 2 wherein the step of receiving the current session state comprises the step of receiving the current session state from the client device.

4. The method of claim 3 wherein the step of receiving the current session state of the digital content comprises the step of receiving the current session state from the group consisting of amount of media rendered, volume, and play lists.

5. The method of claim 4 wherein the step of streaming the digital content comprises the step of streaming music, games, video, pictures, books, or maps.

6. The method of claim 1 wherein the step of receiving the current session state of the digital content comprises the step of receiving the current session state from the group consisting of amount of media rendered, volume, and play lists.

7. The method of claim 1 wherein the step of streaming the digital content to the client device based on the current session state comprises the step of streaming the digital content to the client device based having an amount of media rendered based on the current session state.

8. The method of claim 1 wherein the step of updating the current session state comprises the step of updating an amount of media rendered, a volume, or a play lists.

9. A method comprising the steps of:
receiving session state updates from an application server;
receiving a request for digital content from a client device;
providing the client device with an address for the application server holding the digital content; and
providing the client device with a session state for the digital content.

10. The method of claim 9 wherein the step of receiving session state updates comprises the step of receiving a session state updates from the group consisting of an amount of media rendered, volume, and play lists.

11. The method of claim 10 wherein the step of receiving the request for digital content comprises the step of receiving a request for music, games, video, pictures, books, or maps.

12. A method for operating a content server, the method comprising the steps of:
providing digital content to an external client;
determining a current session state for the digital content; and
providing the current session state of the digital content to an external server.

13. The method of claim 12 wherein the step of providing digital content to the external client comprises the step of providing music, games, video, pictures, books, or maps to the external client.

14. The method of claim 13 wherein the step of determining the current session state comprises the step of determining an amount of media rendered, a volume, or a play lists.

15. An apparatus (102) comprising:
a receiver (221) receiving a request to stream digital content to a client device (106-108) and receiving a current session state of the digital content; and
a transmitter (221) streaming the digital content to the client device based on the current session state and transmitting the current session state to an external server (103).

16. The apparatus of claim 15 wherein the request to stream digital content is received from the client device (106-108).

17. The apparatus of claim 15 wherein the current session state comprises an amount of media rendered a current volume, or a current play list.

18. An apparatus (103) comprising:
a receiver (207) receiving session state updates from an application server (102) and receiving a request for digital content from a client device (106-108); and
a transmitter (207) providing the client device with an address for the application server (102) holding the digital content, and providing the client device with a session state for the digital content.

19. The apparatus of claim 18 wherein the session state comprises an amount of media rendered a current volume, or a current play list.

20. The apparatus of claim 19 wherein the digital content comprises music, games, video, pictures, books, or maps.
